(19) United States
(12) Patent Application Publication
(10) Pub. No.: US 2010/0225136 A1
(43) Pub. Date: Sep. 9, 2010

(54) SEAL MEMBER FOR DOOR

(75) Inventors: Masanori Ogawa, Aichi (JP); Katsumi Terada, Aichi (JP); Junichi Hasegawa, Aichi (JP); Makoto Fujii, Aichi (JP)

Correspondence Address: COOPER & DUNHAM, LLP, 30 Rockefeller Plaza, 20th Floor, NEW YORK, NY, 10112, US

(73) Assignee: NAGOYA OLICHEMICAL CO., LTD., Aichi (JP)

(21) Appl. No.: 12/279,944

(22) PCT Filed: Feb. 19, 2007
(86) PCT No.: PCT/JP2007/052949

§ 371 Date: Aug. 19, 2008

(30) Foreign Application Priority Data
Feb. 21, 2006 (JP) 2006-043235

(51) Int. Cl. B60R 13/02

(52) U.S. Cl. 296/39.1

(57) ABSTRACT

The object of the present invention is to provide a door seal member which is easily fitted into the door of a car. A door seal member 13 is fitted between the door panel 11 and the door trim board 12, wherein the door seal member 13 is manufactured by the vacuum and/or pressure forming or cold working of a foamed sheet, the door seal member 13 being molded into a cubic shape corresponding to that of the door trim board 12.

### FIELD OF THE INVENTION

The present invention relates to a door seal member which is fitted between the door panel and door trim board of a car.

### BACKGROUND OF THE INVENTION

Hitherto, a translucent plastic liner film has been fitted between the door panel and door trim board of a vehicle to suppress the entrance of rainwater into the door. Said liner film is bonded to the door panel with an adhesive. The sound proof sheet disclosed in Patent Literature 1 consists of a foamed plastic resin, and like said liner film, suppresses the entrance of water from the outside of the vehicle, while also reducing the amount of sound entering or escaping from said vehicle.

Said sound proof sheet is equipped by hanging it from its upper to lower side, like a curtain.

Patent Literature 1: Tokkai 2004-323002

### DISCLOSURE OF THE INVENTION

Said conventional sound proof sheet has a problem in that when said sound proof sheet is bonded to the door, with an adhesive, since said sheet is flexible, the unbonded part of said sheet is apt to hang, making the shape of said sheet unstable, resulting in inferior workability when fitting said sheet into the door.

The object of the present invention is to solve said problem, and to provide a door seal member which is easily fitted into the door.

### Means to Solve Said Problems

To attain said object, the invention of Claim 1 relates to a door seal member being fitted between the door panel and door trim board of a vehicle, said door seal member being manufactured by the vacuum and/or pressure forming, or cold working of a foamed sheet, and having a cubic shape corresponding to that of said door trim board.

According to the invention of Claim 1, since said door seal member is made of a foamed sheet, not only the entrance of rainwater into the door, but also the entrance of sound from the outside of the vehicle can be suppressed.

Further, since said door seal member is manufactured by the vacuum and/or pressure forming, or cold working of a foamed sheet to give it a cubic shape, said door seal member also has excellent dimensional stability, making said door seal member easily equipped into the door.

According to the invention of Claim 2, since the periphery part of said door seal member is set to be flat, and the inside part which is surrounded with said periphery part is set to be uneven, said door seal member can easily be equipped into the door by said flat periphery part, and further said door seal member can suppress effectively the entrance of sound with said uneven inside part.

According to the invention of Claim 3, in said door seal member of the invention described in Claims 1 or 2, since a plural number of fixing holes and/or fixing projections are formed in/on said periphery part of said door seal member to fit it into the periphery part of said door trim board, the fixing position of said door seal member in the door can be clearly settled by said fixing holes and/or fixing projections, improving the ease of fitting of said door seal member.

### Effect of the Invention

Said door seal member of the present invention can be easily fitted into the door.

### THE PREFERRED EMBODIMENT TO PRACTICE THE INVENTION

An embodiment in of the present invention is explained below.

As shown in FIGS. 1 and 2, the door 10 of the car relating to this embodiment is equipped with a door panel 11, and a door trim board 12 which is fixed onto one side of said door panel 11. A door seal member 13 (seal member) is fitted into the door 10 by inserting said seal member 13 between said door panel 11 and said door trim board 12.

Firstly, the structure of said door panel 11 is illustrated. A sash 15 extends from the upper edge of said door panel 11 with a window glass 16 being arranged on the inside of said sash 15.

Further, said door panel 11 provides a door outer panel 17 which is arranged on the outside of the car, and further, a door inner panel 18. A plural number of fixing holes 19 are formed in the periphery part to fix said door trim board 12 to said door inner panel 18. Further, a speaker fitting hole 20 is formed in said door inner panel 18 to which a door knob 21 is also fitted.

Next, the structure of said door trim board 12 is illustrated. Said door trim board 12 is equipped with a trim panel 22, and a door armrest 23 which is equipped on the inside face of said trim panel 22. A knob fixing hole 24 to settle the fixing position of said knob 21 is formed in said door panel 22, with a speaker fitting part 25 being settled at the corresponding position of said speaker fitting hole 20. Further, said door armrest 23 is fitted to a fixing hole 19 which is formed at the center of said door inner panel 18 through said trim panel 22.

A fitting groove 26 turning toward the outside of the car is formed at the upper end of said door panel 22 (See FIG. 3).

A weather strip 27 is fitted to said fitting groove 26, said weather strip 27 sticking to said wind glass 16 to suppress the entrance of water into the door 10. Further, fixing projections 28 extend toward said door inner panel 18 from the side of said trim panel 22 (See FIG. 3).

The position of each fixing projection 28 corresponds to the position of each fixing hole 19 of said door inner panel 18, with a clip 29 being mounted at the top of each fixing projection 28. Said trim panel 22 is fixed to said door inner panel 18 by fitting said clips 29 into said fixing holes 19.

Further, said door seal member 13 is illustrated below. Said door seal member 13 is equipped into the door 10 so that said door seal member 13 covers one side of said door inner panel 18, one side of said door panel 18 facing toward the inside of the car, with said door seal member 13 being covered by said door trim panel 22.

The periphery part of said door seal member 13 is set to be flat as a fixing part 31 to said door inner panel 18 and said trim panel 22 (See FIG. 1). Further, the inside part of said door seal member 13, being surrounded with said periphery part which is said fixing part 31, is set to be uneven, so that the inside of said uneven inside part is to be a sound absorbing part 32 (See FIG. 1).

A plural number of fixing holes 33 are formed in said fixing part 31, with the clip 29 of each fixing projection 28 of said trim panel 22 being inserted into each fixing hole 33, said door seal member 13 being fixed to said door inner panel 18 by further fitting each clip 29 into each fixing hole 19 of said door inner panel 18 (See FIG. 3). More precisely, a brim 29a is formed at the base end of each clip 29.

Further, pressing blocks 34 project from the underside of said fitting groove 26 of said trim panel 22. Said brim 29a and said pressing block 34 press the periphery of said fixing hole 33 and said fixing part 31 in a state in which said door seal member 13 is fixed to said door inner panel 18, sticking said door seal member 13 to said door inner panel 18 so as to suppress the entrance of water into the door.

Said door seal member 13 is made of a foamed sheet. As the material for said foamed sheet, a thermoplastic resin like a polyolefine such as polyethylene, polypropylene or the like, polystyrene, polyurethane, or the like, or a foamed synthetic rubber may be used.

Said door seal member 13 is manufactured by the vacuum and/or pressure forming, or cold working of said foamed sheet so that said door seal member 13 has a cubic shape corresponding to that of said trim panel 22 (door trim board 12). Namely the size of said door seal member 13 is set to be covered by said trim panel 22. Further, since said door seal member 13 has said uneven sound absorbing part 32 and so has a cubic shape, said door seal member 13 is easy to erect without drooping, and as a result, is easily equipped into the door 10. Further, said fixing part 31 of said door seal member 13 sticks to said door inner panel 18 to suppress effectively the entrance of water into the door 10.

Since said door seal member 13 is made of a foamed sheet, said door seal member 13 has an excellent sound absorbing property, and in addition, with said uneven sound absorbing part 32, said door seal member 13 has an improved sound blocking property, to block the entrance of sound into the car from the outside.

Further, said door seal member 13 is preferably manufactured by vacuum forming, since in vacuum forming, a mold is easily available, a preferable moldability is ensured, high mold cost is avoided, and the like. Further, a foamed sheet as the material for said door seal member 13 is preferably selected from a foamed thermoplastic resin, since said foamed thermoplastic resin is easily available, highly rigid, of good sound absorption and moldability, and is easily recycled. Further, the shape of the holes and projections of said uneven sound absorbing part 32 are not limited only to a square shape but also a cylindrical shape or polygonal shape or the like. Still further, fixing holes 33 are formed in said fixing part 31 in said door seal member 13 of this embodiment, but alternatively, fixing projections may be formed on said fixing part 31 to fit said fixing projections into fixing holes of said door inner panel 18, or of said trim panel 22.

Further, said uneven sound absorbing part 32 is not necessary for said door seal member 13 in a case where the thickness of said door seal member 13 is increased so as not to droop when it is equipped into the door, or said door seal member 13 has an enough sound absorbing property without said uneven sound absorbing part 32.

Still further, the sizes of holes and projections of said sound absorbing part 32 don't necessarily need to be same, and may be changed arbitrarily according to the space in the door 10 or the surface shapes of said trim panel 22, or of said door inner panel 18.

Still further, said door seal member 13 may be fixed to said door panel 11 and/or said door trim board 12 with an adhesive or screws.

### BRIEF DESCRIPTION OF THE DRAWINGS

FIG. 1 is an exploded perspective view of the door of the vehicle of the embodiment.

FIG. 2 is a perspective view of the door of the vehicle of the embodiment.

FIG. 3 is a sectional view cutting along line 3-3 in FIG. 2.

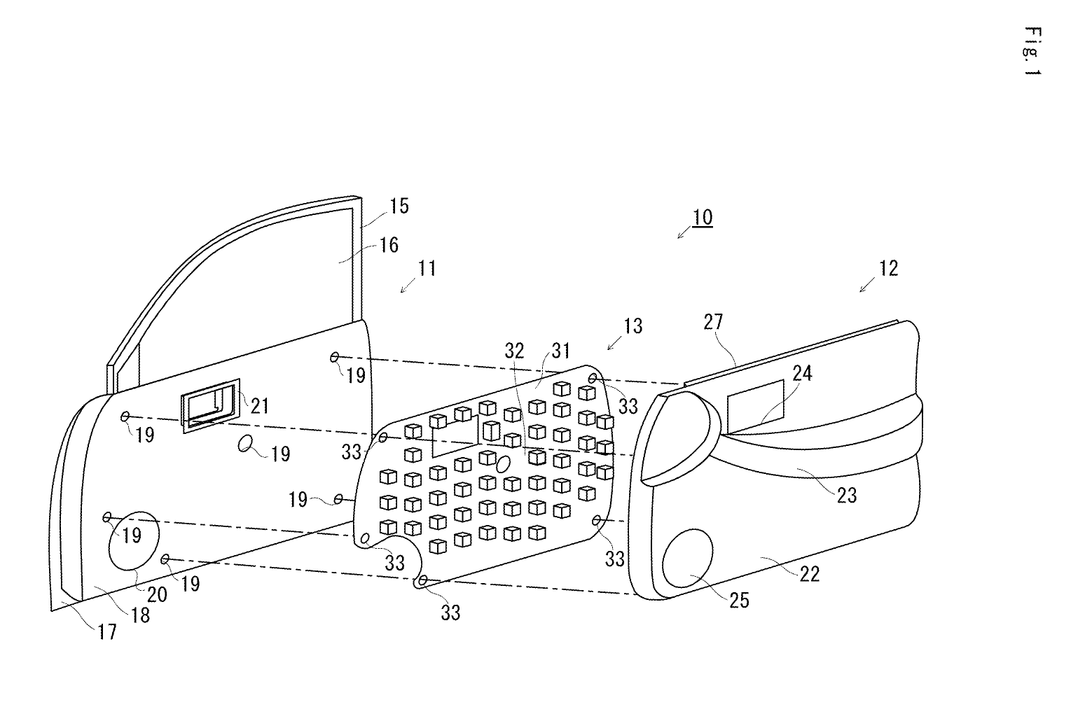

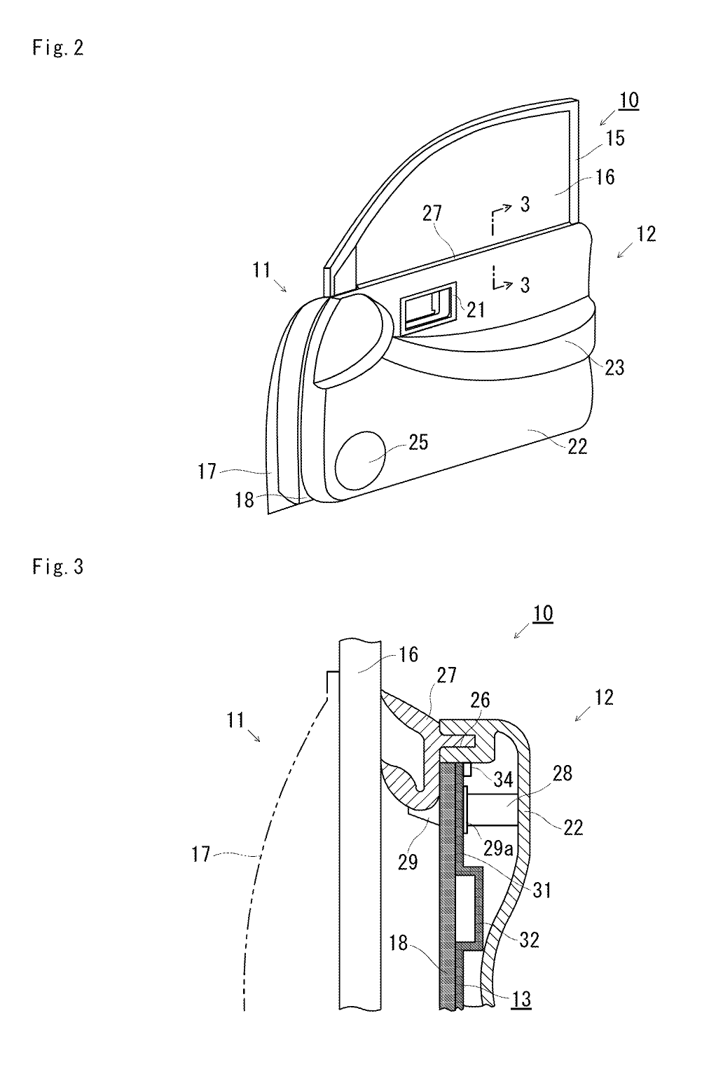

### DESCRIPTION OF NUMBERS

10: Door
11: Door panel
12: Door trim board
13: Door seal member
31: Fixing part being the periphery part of the door seal member
32: Sound absorbing part being the inside part of the periphery part the door seal member
33: Fixing hole

1. A door seal member being fitted between the door panel and door trim board of a vehicle, said door seal member being manufactured by the vacuum and/or pressure forming, or cold working of a foamed sheet, and having a cubic shape corresponding to that of said door trim board.

2. A door seal member in accordance with claim 1, wherein the periphery part of said door seal member is set to be flat, while the inside part, being surrounded with said periphery part, is set to be uneven.

3. A door seal member in accordance with claim 2, wherein a plural number of fixing holes and/or fixing projections are formed in/on said periphery part, said periphery part being fixed to the periphery of said door trim board through said fixing holes and/or fixing projections.
